(19) United States
(12) Patent Application Publication
(10) Pub. No.: US 2010/0304320 A1
(43) Pub. Date: Dec. 2, 2010

(54) KILN

(75) Inventor: Charlie Martella, Western Australia (AU)

Correspondence Address: JAMES D. STEVENS;REISING ETHINGTON P.C., P.O. BOX 4390, TROY, MI, 48099, US

(73) Assignee: ANSAC PTY LTD., Bunbury, Western Australia (AU)

(21) Appl. No.: 12/741,439

(22) PCT Filed: Nov. 4, 2008
(86) PCT No.: PCT/AU08/01634

§ 371 Date: Aug. 13, 2010

(30) Foreign Application Priority Data
Nov. 5, 2007 (AU) 2007906057
Mar. 14, 2008 (AU) 2008901280

(51) Int. Cl. F27B 7/36

(52) U.S. Cl. 432/105

(57) ABSTRACT

A kiln comprising a substantially cylindrical drum (11) supported from a support structure for rotation about its central axis whereby the drum is supported such that the central axis is generally horizontal and whereby the drum is configured and/or arranged such that rotation of the drum will cause fluid particulate material to flow from one end (13) to other end (15). The one end being associated with a fuel inlet (33) and the other end being provided with a discharge (37) for combustion products and heat. The inner face of the side wall of the drum is provided with a plurality of ports (29) which are located at spaced intervals along and around the interior of the drum and which open into the interior of the drum, the one end being closed by an end assembly (23) fixed relative to the support structure whereby the one end is in close abutting relationship with the end assembly. An opening (25) is provided in the end assembly, the opening connected to a source of air (31). A set of passageways (27) are provided at angularly displaced positions around the kiln, said passageways communicating with the ports, the inlets of passageways opening into the face defining the one end, the opening being positioned such that on rotation of the drum the inlets of the passageways rotate past the opening.

### FIELD OF THE INVENTION

This invention relates to combustion kilns. The particular application of the invention relates to a combustion kiln which can be utilized for the combustion of materials for the generation of heat energy.

### BACKGROUND ART

The following discussion of the background art is intended to facilitate an understanding of the present invention only. The discussion is not an acknowledgement or admission that any of the material referred to is or was part of the common general knowledge as at the priority date of the application.

A particular application of the combustion kiln according to the invention relates to one which can be utilized for the combustion of waste materials for the production of heat energy and which may, if desired, be used for the generation of electricity. In recent times it has been realised that potential fuels which can be utilized for the generation of heat can include bio-waste materials such as manures which have previously been considered as waste materials which have had little commercial value. Examples of such waste products comprise refuse, chicken manure and the like. A difficulty which has been faced in the past is the safe and efficient burning of such materials with the minimum of pollution resulting from such combustion.

### DISCLOSURE OF THE INVENTION

Throughout the specification and claim unless the context requires otherwise, the word “comprise” or variations such as “comprises” or “comprising”, will be understood to imply the inclusion of a stated integer or group of integers but not the exclusion of any other integer or group of integers.

According to one aspect the invention resides in a combustion kiln comprising a substantially cylindrical drum supported from a support structure for rotation about its central axis whereby the drum is supported such that the central axis is generally horizontal, the internal face of the wall of the drum being lined with a refractory material, whereby the drum is configured and/or arranged such that rotation of the drum will cause fluid particulate material to flow from one end to other, said one end being associated with an inlet arranged and configured to enable the particulate material to be delivered into the inlet, wherein the particulate material comprises at least in part material which capable of combustion, the other end being provided with a discharge for combustion products and heat, the inner face of the side wall of the drum being provided with a plurality of ports which are located at spaced intervals along and around the interior of the drum and which open into the interior of the drum, the one end being closed by an end plate fixed relative to the support structure to sealingly overlie the one end, an opening provided in the end assembly, the opening connected to a source of air, a set of passageways provided at angularly displaced positions around the kiln, said passageways extending substantially axially from the one end and being accommodated at least partially in the refractory material, said passageways communicating with the ports, the passageways each having an inlet opening at the face defining the one end, the opening being positioned such that on rotation of the drum the inlets of the passageways rotate past the opening, the opening being positioned such that the inlets communicate with the opening in the lower portion of their rotation path.

According to a preferred feature of the invention the opening is associated with a plenum chamber which overlies the opening, the plenum chamber being connected to the source of air,

According to another aspect the invention resides in a combustion kiln comprising a substantially cylindrical drum supported from a support structure for rotation about its central axis the internal face of the wall of the drum being lined with a refractory material, whereby the drum is supported such that the central axis is generally horizontal and whereby the drum is configured and/or arranged such that rotation of the drum will cause fluid particulate material to flow from one end to other, said one end being associated with an inlet arranged and configured to enable the particulate material to be delivered into the inlet, the particulate material comprises at least in part material which is capable of combustion, the other end being provided with a discharge for combustion products and heat, the inner face of the side walls of the drum being provided with a plurality of ports which are located at spaced intervals along and around the interior of the drum, a set of passageways extending through refractory material from the one end and providing fluid communication between the one end and the ports, an air inlet at the one end and arranged and configured to communicate. with the passageways on rotation of the drum when said ports are in the lower portion of their rotation path.

According to a preferred feature of the invention the one end is closed by an end assembly fixed relative to the support structure whereby the end assembly is maintained in close abutting end to end relationship with the one end, the air inlet comprising an opening provided in the end assembly and a plenum chamber which is intended in use to be connected to a source of air, the plenum chamber overlying the opening, the opening being positioned such that on rotation of the drum the ends of the passageways at the one end rotate past the opening.

According to a preferred feature of the invention the end assembly comprises an end pate which overlies the one end and the opening is provided through the plate.

According to a preferred feature of the invention the opening is part annular, is concentric with the drum and lies in the rotation path of the ends of the passageways at the one end.

According to a preferred feature of the invention said passageways are spaced substantially equi-angularly around the drum.

According to a preferred feature of the invention the wall of the kiln is defined by an outer shell and the refractory material is located on the inner face of the shell.

According to a preferred feature of the invention the passageways are defined by channels located in the outer face of the refractory lining and wherein the channels are closed by the outer shell.

According to a preferred feature of the invention the passageways are formed within the refractory material between the inner and outer face thereof.

According to a preferred feature of the invention each passageway communicates with a plurality of ports located at spaced intervals along the drum.

According to a preferred feature of the invention, the kiln further comprises a burner located in the region of the one end, the burner directed towards the interior face at the lower portion of the rotation path of the wall. According to a preferred feature of the invention the outlet of the burner is located such that it is directed onto the portion of the interior face as it rotates from the lowermost portion of the lower portion of the rotation path.

According to a preferred feature of the invention the interior of the drum is isolated from the exterior.

According to a preferred feature of the invention the interior face of the wall is formed with inwardly projecting protrusions. According to a preferred feature of the invention the protrusions comprise a set of rib like formations. According to a preferred feature of the invention the rib-like protrusions have a helical configuration. According to a preferred feature of the invention the passageways are substantially parallel with the central axis of the drum. According to a preferred feature of the invention the passageways are configured to axially conform with the axial configuration of the rib-like protrusions. According to a preferred feature of the invention the passageways are generally located in one to one relationship with the rib-like protrusions. According to a preferred feature of the invention the ports open into the interior of the drum at the trailing face of the protrusions. According to a preferred feature of the invention the ports open into the inner face in the region of the base of the trailing edge of the protrusions.

The invention will be more fully understood in the light of the following description of several specific embodiments

### BRIEF DESCRIPTION OF THE DRAWINGS

The description is made with reference to the accompanying drawings of which:

FIG. 1 is a schematic side elevation of a combustion kiln according to the first embodiment;

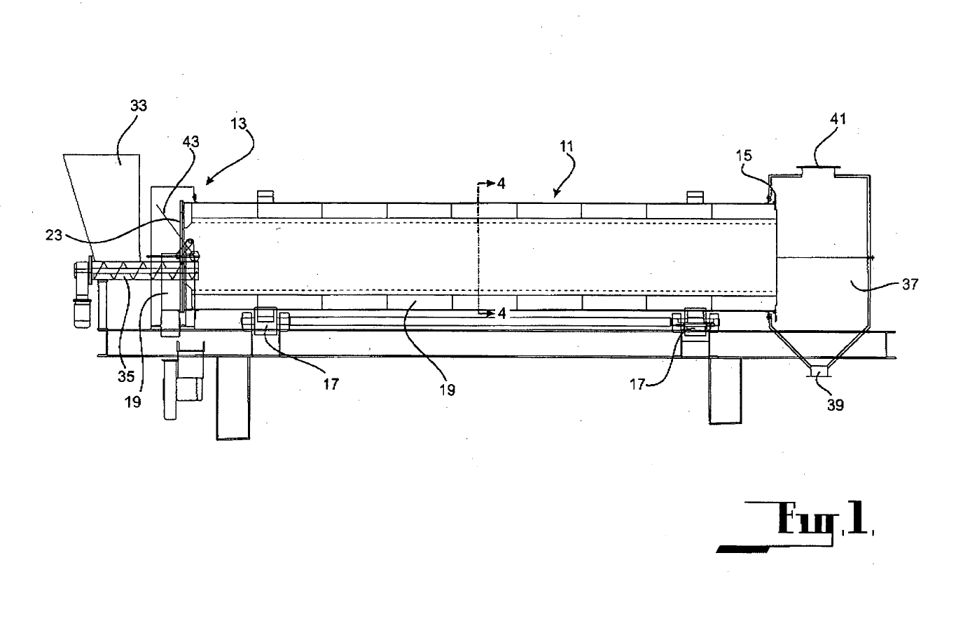

FIG. 2 is a plan view of a combustion kiln according to the first embodiment;

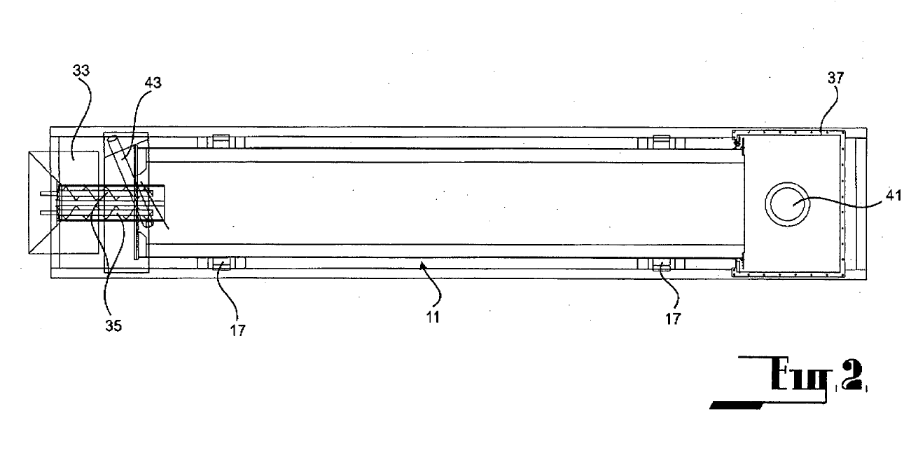

FIG. 3 is an enlarged side elevation of the one end of the drum and the associated plenum chamber and fuel inlet according to the first embodiment; and

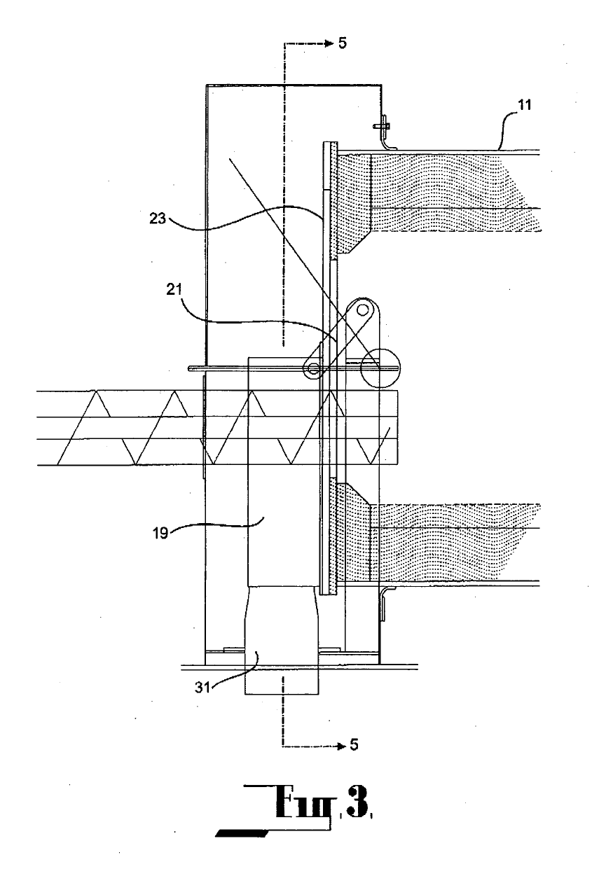

FIG. 4 is a sectional view along line 4-4 of FIG. 1;

FIG. 5 is a sectional view along line 5-5 of FIG. 3; and

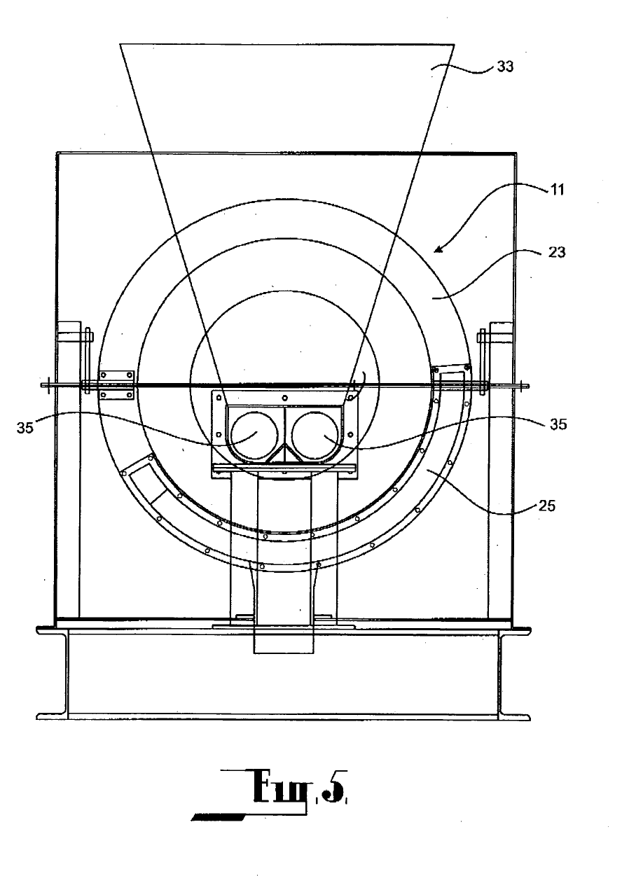

FIG. 6 is an end elevation of the drum according to the second embodiment.

### DETAILED DESCRIPTION OF SPECIFIC EMBODIMENTS

The embodiment comprises a combustion kiln having a rotating drum 11 which is cylindrical and is supported such that it is rotatable about its central axis and whereby the support for the drum is such that the central axis is substantially horizontal but with some degree of inclination in order that with rotation of the drum and on entry of particulate material into one end 13, the material will flow towards the other end 15. The drum is supported upon suitable rollers shown schematically at 17 and is driven by a suitable rotary drive. In addition the drum and is fixed axially in the region of an end of the drum to enable expansion and contraction due to thermal expansion and contraction from that end.

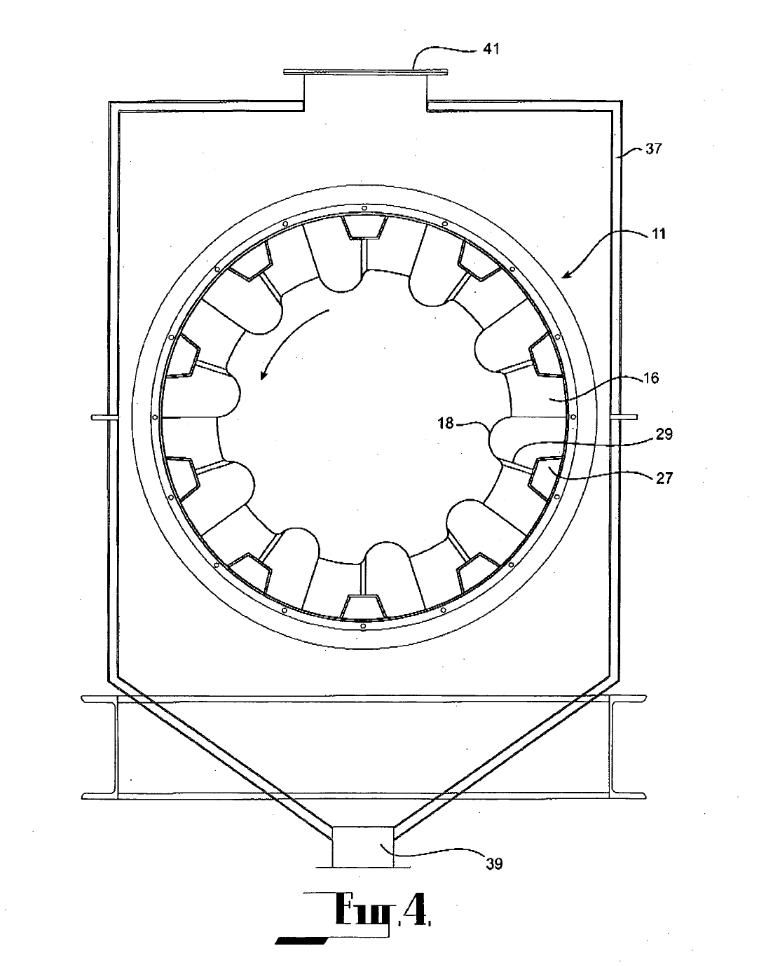

The interior of the drum is lined with refractory 16 which, as shown in FIG. 4, is formed with a set of generally axial ribs 18 which extend along the length.

One end 13 of the drum is closed by an end assembly which comprises an end plate 23 and a plenum chamber 19 which overlies the end plate 23. The end plate is received over the end face of the one end 13 and serves to close the end face. The end plate 23 and is formed with a part annular slotted opening 25 which is concentric with the drum and is positioned to overlie the lower portion of the rotation path of the refractory wall of the drum. The plenum chamber 19 overlies the opening 25. The plenum chamber is connected to a forced air supply through an inlet 31. The end assembly is supported from the support structure for the kiln by a pair of pivotal links located one to each side of the drum. The pivotal links each, comprise a link member 21 which is pivotally connected at one end to the end plate and the other end to the support such that the end assembly is gravitationally biased into face to face engagement with the end face but is able to move axially as a result of the expansion and contraction of the drum and any eccentricity of the drum whilst maintaining face to face engagement with the end face of the drum.

The refractory wall 16 of the drum is formed with a set of axial passageways 27 which extend for the length of the drum and which are substantially eqi-angularly spaced around the drum. The passageways 27 are formed by channels which are formed in the outer face of the refractory and the channels are closed at their outer face by the outer shell of the drum. Each of the passageways is associated with a set of radial ports 29 which are located at spaced intervals along the wall. The ports 29 each extend between the interior face of the refractory wall 16 and the respective passageway. The ports open into the inner face of the refractory wall near the trailing face of the ribs 19. The location of the opening of the ports at the trailing face of the ribs serves to prevent blockage of the ports as well as entering the material within the drum whilst it is being influenced by the rib.

The passageways 27 each open into the end face of the one end of the drum and on rotation of the drum they will each pass over the slotted opening in the end plate to provide communication between the respective set of ports and the plenum chamber. Therefore there is only communication between the radial ports and the plenum chamber and the source of pressurized air when the passageways 27 are in the lowermost portion of their rotation path.

The one end is further associated with an inlet hopper 33 into which particulate feedstock, which is to comprise the fuel of the kiln, is deposited. The hopper 33 has a screw feed 35 at the base of the inlet hopper which provides a controlled delivery of fuel into the interior of the drum 11.

The other end 15 of the drum is provided with an outlet chamber 37 which has a lower outlet 39 for the passage of ash and an upper outlet 41 for the passage of gaseous combustion products and heat form the kiln. The configuration of the outlet chamber enables the interior of the drum to be isolated from the ambient conditions to the exterior of the drum.

The kiln is further associated with a burner 43 which is located at the one end 33 and is positioned such that the flame generated by the burner is directed towards the interior wall of the drum and in particular the portion of the wall as it moves in its rotation path from the lowermost portion of the rotation path.

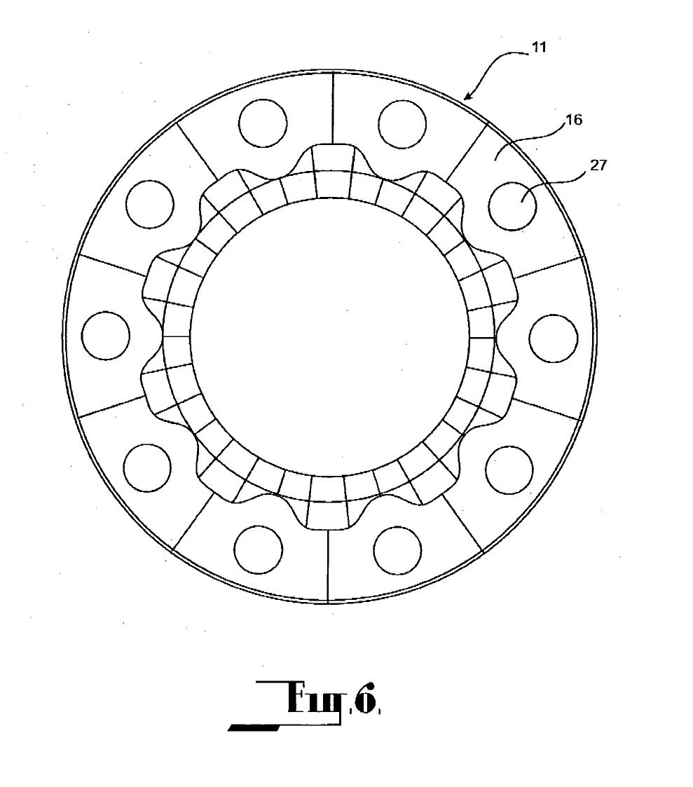

In the case of the second embodiment as shown at FIG. 6 the passageways 27 are formed within the refractory lining 16 between the inner and outer face

In the case of both embodiments it is intended that when in use, the burner will be active for as long as it takes to reach the desired ignition temperature of the feedstock which has been delivered into the kiln and once combustion of the feedstock has been established. Once the combustion has been established the burger can be shut down. The burner is associated with an appropriate sensor and control means such in order that it can be reignited if combustion ceases.

It is believed that the combustion kiln according to each of the embodiments, will be particularly efficient in its operation because of the delivery of the air into the particulate material which is resident in the lower portion of the drum. The introduction of such air serves to not only effect inter-mixing of the feedstock, but also into the mixing with air which will enhance the combustion process. In addition the delivery of the air though the passageways which are formed in the refractory lining serves to both cool the refractory and to heat the air being delivered to the ports by the passageways for the reintroduction of. such heat into the combustion chamber.

According to another embodiment the ribs can have a helical configuration to facilitate the transport of material along the length of the drum.

According to another embodiment the inlet hopper 33 is be associated with a drying means which facilitates, drying of the feedstock prior to delivery to the hopper 33 and the heat for drying the material is sourced from the heat output of the kiln.

According to another embodiment the air being delivered into the plenum chamber is heated and the heat for heating the air is sourced from the heat output of the kiln.

The present invention is not to be limited in scope by any of the specific embodiments described herein. These embodiments are intended for the purpose of exemplification only. Functionally equivalent products, materials and methods are clearly within the scope of the invention as described herein.

1. A combustion kiln comprising a substantially cylindrical drum supported from a support structure for rotation about its central axis whereby the drum is supported such that the central axis is generally horizontal, the internal face of the wall of the drum being lined with a refractory material, whereby the drum is configured and/or arranged such that rotation of the drum will cause fluid particulate material to flow from one end to other, said one end being associated with an inlet arranged and configured to enable the particulate material to be delivered into the inlet, wherein the particulate material comprises at least in part material which capable of combustion, the other end being provided with a discharge for combustion products and heat, the inner face of the side wall of the drum being provided with a plurality of ports which are located at spaced intervals along and around the interior of the drum and which open into the interior of the drum, the one end being closed by an end plate fixed relative to the support structure to sealingly overlie the one end, an opening provided in the end assembly, the opening connected to a source of air, a set of passageways provided at angularly displaced positions around the kiln, said passageways extending substantially axially from the one end and being accommodated at least partially in the refractory material, said passageways communicating with the ports, the passageways each having an inlet opening at the face defining the one end, the opening being positioned such that on rotation of the drum the inlets of the passageways rotate past the opening, the opening being positioned such that the inlets communicate with the opening in the lower portion of their rotation path.

2. A combustion kiln as claimed at claim 1 wherein the opening is associated with a plenum chamber which overlies the opening, the plenum chamber being connected to the source of air,

3. (canceled)

4. (canceled)

5. A combustion kiln comprising a substantially cylindrical drum supported from a support structure for rotation about its central axis, the internal face of the wall of the drum being lined with a refractory material, whereby the drum is supported such that the central axis is generally horizontal and whereby the drum is configured and/or arranged such that rotation of the drum will cause fluid particulate material to flow from one end to other, said one end being associated with an inlet arranged and configured to enable the particulate material to be delivered into the inlet, the particulate material comprises at least in part material which is capable of combustion, and the other end being provided with a discharge for combustion products and heat, the inner face of the side walls of the drum being provided with a plurality of ports which are located at spaced intervals along and around the interior of the drum, a set of passageways extending through the refratory material from the one end and providing fluid communication between the one end and the ports, an air inlet at the one end and arranged and configured to communicate with the passageways on rotation of the drum when said ports are in the lower portion of their rotation path.

6. A combustion kiln as claimed at claim 5 wherein the one end is closed by an end assembly fixed relative to the support structure whereby the end assembly is maintained in close abutting end to end relationship with the one end, the air inlet comprising an opening provided in the end assembly and a plenum chamber which is intended in use to be connected to a source of air, the plenum chamber overlying the opening, the opening being positioned such that on rotation of the drum the ends of the passageways at the one end rotate past the opening.

7. A combustion kiln as claimed at claim 5 or 6 wherein the end assembly comprises an end pate which overlies the one end and the opening is provided through the plate.

8. A combustion kiln as claimed at any one of the preceding claims wherein the opening is part annular, is concentric with the drum and lies in the rotation path of the ends of the passageways at the one end.

9. A combustion kiln as claimed at any one of the preceding claims wherein said passageways are spaced substantially equi-angularly around the drum.

10. A combustion kiln as claimed at any one of the preceding claims wherein the wall of the kiln is defined by an outer shell and the refractory material is located on the inner face of the shell.

11. A combustion kiln as claimed at claim 9 wherein the passageways are defined by channels located in the outer face of the refractory lining and wherein the channels are closed by the outer shell.

12. A combustion kiln as claimed at claim 9 wherein the passageways are formed within the refractory material between the inner and outer face thereof.

13. A combustion kiln as claimed at any one of the preceding claims wherein each passageway communicates with a plurality of ports located at spaced intervals along the drum.

14. A combustion kiln as claimed at any one of the preceding claims wherein, the kiln further comprises a burner located in the region of the one end, the burner directed towards the interior face at the lower portion of the rotation path of the wall.

15. A combustion kiln as claimed at claim 13 wherein, the outlet of the burner is located such that it is directed onto the portion of the interior face as it rotates from the lowermost portion of the lower portion of the rotation path.

16. A combustion kiln as claimed at any one of the preceding claims wherein, the interior of the drum is isolated from the exterior.

17. A combustion kiln as claimed at any one of the preceding claims wherein the interior face of the wall is formed with inwardly projecting protrusions.

18. A combustion kiln as claimed at claim 16 wherein the protrusions comprise a set of rib like formations.

19. A combustion kiln as claimed at claim 17 wherein the rib-like protrusions have a helical configuration.

20. A combustion kiln as claimed at claim 17 wherein the passageways are substantially parallel with the central axis of the drum.

21. A combustion kiln as claimed at claim 17 wherein the passageways are configured to axially conform with the axial configuration of the rib-like protrusions.

22. A combustion kiln as claimed at any one of claims 17 to 20 wherein the passageways are generally located in one to one relationship with the rib-like protrusions.

23. A combustion kiln as claimed at any one of claims 16 to 21 wherein the ports open into the interior of the drum at the trailing face of the protrusions.

24. A combustion kiln as claimed at claim 22 wherein the ports open into the inner face in the region of the base of the trailing edge of the protrusions.

25. A combustion kiln substantially as herein described with reference to the accompanying drawings.
